(19) United States
(12) Patent Application Publication
(10) Pub. No.: US 2018/0074812 A1
(43) Pub. Date: Mar. 15, 2018

(54) INFORMATION TERMINAL, INFORMATION PROCESSING SYSTEM, METHOD, AND RECORDING MEDIUM

(71) Applicants: Takuji KAWAGUCHI, Kanagawa (JP); Tomoe Kitaguchi, Kanagawa (JP)

(72) Inventors: Takuji KAWAGUCHI, Kanagawa (JP); Tomoe Kitaguchi, Kanagawa (JP)

(21) Appl. No.: 15/699,747

(22) Filed: Sep. 8, 2017

(30) Foreign Application Priority Data
Sep. 9, 2016 (JP) 2016-176208
Dec. 14, 2016 (JP) 2016-242045
May 16, 2017 (JP) 2017-097311

(51) Int. Cl. G06F 9/445; G06F 17/30; G06F 9/44; H04L 29/08

(52) U.S. Cl. CPC G06F 8/665; H04L 67/2852; G06F 8/71; G06F 17/30365

(57) ABSTRACT

An information terminal transfers information for updating an electronic device to the electronic device. The terminal includes a downloader, a memory, and an update assistance unit. The downloader downloads the information via a network. The memory stores the information downloaded by the downloader. The update assistance unit starts with download of the information and transfers to the electronic device the information stored in the memory by the download.

### CROSS-REFERENCE TO RELATED APPLICATIONS

This patent application is based on and claims priority pursuant to 35 U.S.C. § 119(a) to Japanese Patent Application Nos. 2016-176208, filed on Sep. 9, 2016, 2016-242045, filed on Dec. 14, 2016, and 2017-097311, filed on May 16, 2017, in the Japan Patent Office, the entire disclosure of each of which is hereby incorporated by reference herein.

### BACKGROUND

### Technical Field

Aspect s of the present disclosure relates to an information terminal, an information processing system, a method, and a recording medium.

### Related Art

Many programs (firmware) installed in devices can be updated for trouble shooting and function addition. To execute update, a server function may be added for downloading the firmware to the device. In addition, to take in the firmware, new devices such as a universal serial bus (USB) memory and an SD card, and a physical interface are also being added. However, introducing the server function to each device and adding the new physical devices and the interface cause an adverse effect of increasing costs of the devices. On the other hand, a technique is also known that acquires update data onto a general-purpose terminal such as a personal computer (PC) or a smart device, and transmits the update data to the device, to perform update.

### SUMMARY

In an aspect of the present disclosure, there is provided an information terminal to transfer information for updating an electronic device to the electronic device. The terminal includes a downloader, a memory, and an update assistance unit. The downloader downloads the information via a network. The memory stores the information downloaded by the downloader. The update assistance unit starts with download of the information and transfers to the electronic device the information stored in the memory by the download.

In another aspect of the present disclosure, there is provided an information processing system that includes an electronic device, an information terminal, an electronic device, and an information terminal. The electronic device is connectable to a network, to operate a program to provide a function. The information terminal transfers information for updating the electronic device to the electronic device to assist updating of the electronic device. The information terminal includes a downloader, a memory, and an update assistance unit. The downloader downloads the information via a network. The memory stores the information downloaded by the downloader. The update assistance unit starts with download of the information by the downloader and transfers the information stored in the memory to the electronic device in response to completion of the download.

In still another aspect of the present disclosure, there is provided a method for causing an information processing device to function as an information terminal to update an electronic device. The method is to be executed by the information terminal. The method includes downloading, with a downloader, information to be used for updating the electronic device via a network; sharing the information downloaded by the downloader with an application via a memory; and transferring the information stored in the memory to the electronic device in response to completion of the downloading of the information by the downloader.

In still yet another aspect of the present disclosure, there is provided a non-transitory recording medium that stores a device executable program that causes an information processing device to execute a method for causing the information processing device to function as an information terminal to update an electronic device. The method includes downloading, with a downloader, information to be used for updating the electronic device via a network; storing the information downloaded by the downloader in a memory; starting an update assistance unit with the downloading of the information by the downloader; and transferring the information stored in the memory from the update assistance unit to the electronic device in response to completion of the downloading.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view of an information processing system 100 of a present embodiment;

FIG. 2 is a diagram illustrating a hardware block 200 of a device 102 of the present embodiment;

FIG. 3 is a diagram illustrating a hardware block 300 of a smartphone 105 as an example of an information terminal;

FIG. 4 is a diagram illustrating a function block 400 of the smartphone 105 as an example of an information terminal of the present embodiment;

FIG. 5 is a diagram illustrating a function block 500 of the device 102 of the present embodiment;

FIG. 6 is a diagram illustrating a processing sequence 600 between a server 110 and the smartphone 105 of the present embodiment;

FIG. 7 is a diagram describing a sequence of update of a device by an update assistance unit 402 installed in the processing sequence 600 of FIG. 6;

FIG. 8 is a diagram illustrating a sequence of a second embodiment executed by an app acquisition unit 401 of the present embodiment, in the present embodiment;

FIG. 9 is a diagram illustrating a sequence of yet another embodiment executed by the update assistance unit 402 of the present embodiment;

FIG. 10 is a flowchart illustrating processing after the update assistance unit 402 of the present embodiment is started until a user updates the device 102;

FIG. 11 is a flowchart illustrating processing after the update assistance unit 402 of the present embodiment is started until the user updates the device 102;

FIG. 12 is a diagram illustrating an embodiment of a graphical user interface (GUI) 1200 provided by the update assistance unit 402 when the smartphone 105 that is one embodiment of the information terminal of the present embodiment is used to update the device;

FIG. 13 is a diagram illustrating an embodiment of a GUI 1300 of a device confirmation screen presented by the update assistance unit 402 of the present embodiment;

FIG. 14 is a diagram illustrating an embodiment of a GUI 1400 displayed when the smartphone 105 that is one embodiment of the information terminal of the present embodiment is used to acquire device information by Near Field Communication (NFC);

FIG. 15 is a diagram illustrating an example of a GUI 1500 of an app selection screen displayed by an operating system (OS) of the present embodiment;

FIG. 16 is a diagram illustrating a function block 1600 of the smartphone 105 as an example of an information terminal including an update tool having an integrated configuration in the present embodiment;

FIGS. 17A to 17C are diagrams illustrating examples of a screen of a web page to download an update file; and

FIG. 18 is a diagram describing a sequence of update of the device by an update tool 1601.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

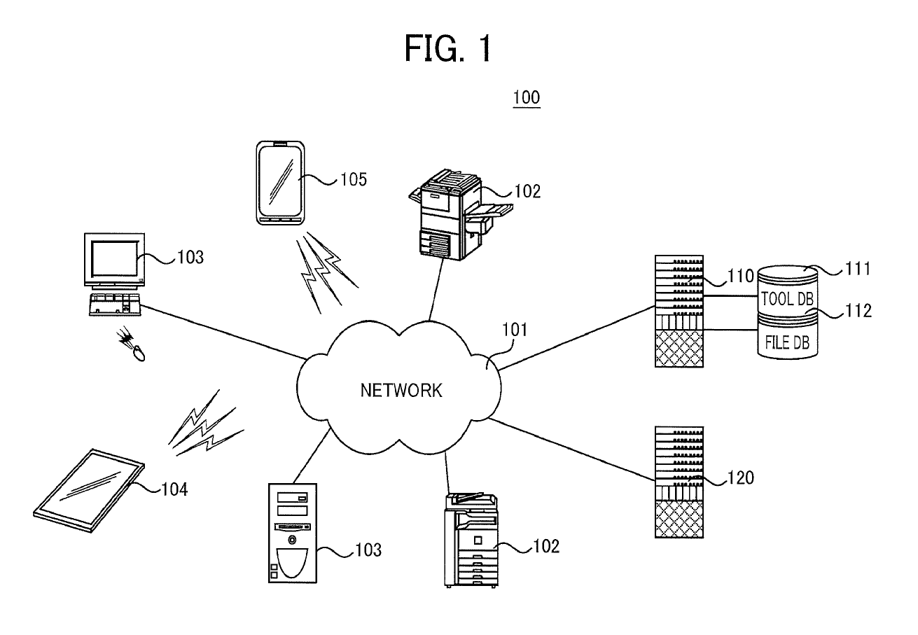

Hereinafter, embodiments of the present disclosure will be described; however, embodiments of the claimed invention are not limited to the embodiments to be described later. FIG. 1 is a schematic view of an information processing system 100 of a present embodiment. The information processing system 100 illustrated in FIG. 1 includes a plurality of devices 102 such as a multi-function peripheral (MFP), a personal computer (PC) 103, a tablet PC 104, and a smartphone 105 that are connected together in a network 101. The network 101 can include either or both of the Internet or a local area network (LAN).

The network 101 is connected to the device 102 such as the MFP as an example of an information processing device, and information terminals such as the smartphone 105, the PC 103, the tablet PC 104, and a mobile phone. However, the information processing device connected to the network 101 is not limited to these devices, and not limited in particular as far as it is a device capable of performing information communication via the network 101.

The network 101 is connected to servers 110 and 120. The server 110 can be provided by a provider that provides service on an application via the network 101, and enables update of the application and update of firmware. The server 120 is a server provided by the information terminal such as the PC 103, a tablet type PC, or the smartphone 105 connected to the network 101, and supports an operating system (hereinafter referred to as an OS) of each of the PC 103, the tablet type PC, and the smartphone 105, and supports security update and other OS level updates.

The server 110 can include a tool DB 111 and a file DB 112 in the present embodiment. The tool DB 111 stores an independent download tool to download a program such as the firmware from the server 110. In addition, the file DB 112 manages an object code, a binary code, and another execution code of the program and the firmware to be updated, for each device. The file DB 112, when receiving a download request in accordance with the present embodiment from the smartphone 105, causes the smartphone 105 to acquire both the execution code and runtime data of the program into the smartphone 105.

Incidentally, in the present embodiment, download of the program and download of the data are executed from the information terminal such as the smartphone 105 in a pull method by using browser software, on the basis of HTTP 2.0 paradigm. This is because, depending on a device configuration of the information terminal, an OS having high shielding property is used that inhibits direct access to a file from an application that can be used on the information terminal by a user (a program code referred to as a so-called app; hereinafter, simply referred to as an app).

The OS having high shielding property includes iOS (registered trademark), and MacOS (registered trademark), for example; however, the OS is not limited to these OSs. In this case, a disadvantage occurs that a file for update downloaded by an app cannot be selected from the app performing the download, and the function of the app is not achieved.

For this reason, in the present embodiment, a memory area referred to as a so-called web cache assigned to the browser software out of memory areas of the information terminal is used as a cache area used by the app. For this reason, the file downloaded by the browser software is managed by the browser software. Although the browser software is an application to be recognized as a module of the OS, the browser software can be independently started.

On the other hand, from the browser software, it is possible to start an intended app with a method of, for example, operating JavaScript (registered trademark), or describing a file name to link a uniform resource locator (URL) of the app and read the app. That is, for information downloaded by the browser software, the data can be shared even in a case where the information cannot be operated from the app. Therefore, it has been found that it is possible to pass a downloaded file identification value as an argument to the app when the app is called from the browser software.

That is, in the present embodiment, download of update data to be downloaded is performed by using the browser software as a download agent, and maintenance such as update of the firmware of the device is possible by using the information terminal without depending on characteristics such as shielding property and confidentiality of the OS.

Incidentally, the present embodiment can be applied not only to the above-described OS having high shielding property, but also to a relatively open OS not having high shielding property, such as Windows (registered trademark), Android (registered trademark), or CHROME (registered trademark).

The servers 110 and 120 can provide a plurality of functions such as a so-called web server, storage server, and authentication server, and can be configured by implementing to a server dedicated machine a server OS such as Windows Server (registered trademark), UNIX (registered trademark), or LINUX (registered trademark). The servers 110 and 120 each mount a central processing unit (CPU), and include memory such as random access memory (RAM) and read-only memory (ROM), and a display device, and can connect to a keyboard, a mouse, an external hard disk, an optical memory device, and the like by an interface such as USB or SATA via a bus bridge such as PCI or PCI Express, to provide functions of the servers.

The web server function includes, for example, Apache (registered trademark), IIS (registered trademark), CERN (registered trademark), NSCA (registered trademark), AN (registered trademark), Cherokee (registered trademark) but is not limited to these functions. Further, the servers 110 and 120 can use server programs such as PHP, Java (registered trademark), and Perl, to provide service such as CGI. Besides, the servers 110 and 120 each can provide a plurality of server functions by a single server device; however, a plurality of servers as rack mount type servers also can provide each function of the server 110 or the server 120.

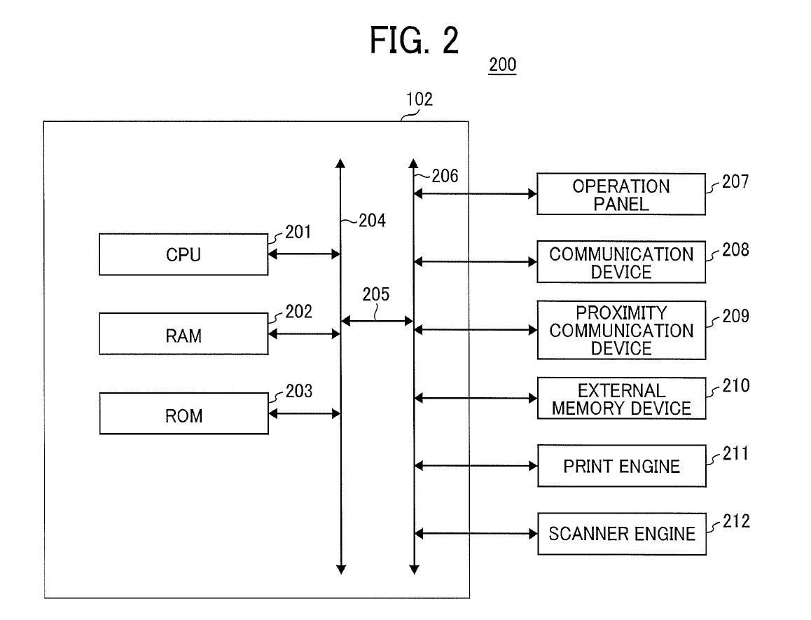

FIG. 2 illustrates a hardware block 200 of the device 102 of the present embodiment. The device 102 can be implemented as the MFP; however, its device configuration, such as a network connectable printer, copier, and facsimile, is not limited. The device 102 includes a CPU 201, RAM 202, and ROM 203 connected to each other by a system bus 204. The CPU 201 controls operation of the entire device 102, and reads a program into the RAM 202 and executes the program to provide a function of the device 102 electronically.

The ROM 203 can store a basic program such as Basic Input/Output System (BIOS) and in addition firmware used by the device 102, and a program written in the ROM 203 is read into the RAM 202, and the CPU 201 reads the program from the RAM 202 to enable execution of the program.

The system bus 204 is connected to an Input/Output (I/O) bus 206 via a bus bridge 205 such as PCI or PCI Express. The I/O bus 206 is connected to an external memory device 210 such as an operation panel 207, a communication device 208, a proximity communication device 209, a hard disk drive (HDD), an SD card, or a digital versatile disc (DVD) via an appropriate protocol, and enables input/output from/to the server 110. Further, as an auxiliary memory device, EEPROM (registered trademark) or EPROM (registered trademark) can be connected as the external memory device 210.

The communication device 208 of the present embodiment enables communication such as wireless communication such as IEEE.802.11x, and in addition an audio call using 900 MHz band, wireless fidelity (WiFi) communication such as 3G, 4G, or LTE, IrDa, and Bluetooth (registered trademark). In addition, the proximity communication device 209 of the present embodiment enables non-contact type proximity communication such as Near Field Communication (NFC), and can perform communication by holding a target device without physical contact. Further, the device 102 includes a print engine 211 that uses an electrophotography method or an inkjet method to enable image formation, and a scanner engine 212 that uses a charge coupled device (CCD) array to read an image and generates a digital image, and provides various functions for the user.

The CPU used by the device 102 includes more specifically, for example, PENTIUM (registered trademark) to PENTIUM IV (registered trademark), ATOM (registered trademark), CORE2DUO (registered trademark), CORE2QUAD (registered trademark), and COREi (registered trademark) series, and in addition XEON (registered trademark), PENTIUM (registered trademark) compatible CPU, POWERPC (registered trademark), and MIPS, but is not limited to these CPUs.

The operating system (OS) to be used includes Windows Server (registered trademark), UNIX (registered trademark), LINUX (registered trademark), OPENBSD or another appropriate OS. Further, the device 102 can store and execute an application program written in a programming language such as an assembler language, C, C++, Visual C++, Visual Basic, Java (registered trademark), JavaScript (registered trademark), Perl, or Ruby, the program being operated on the above described OS.

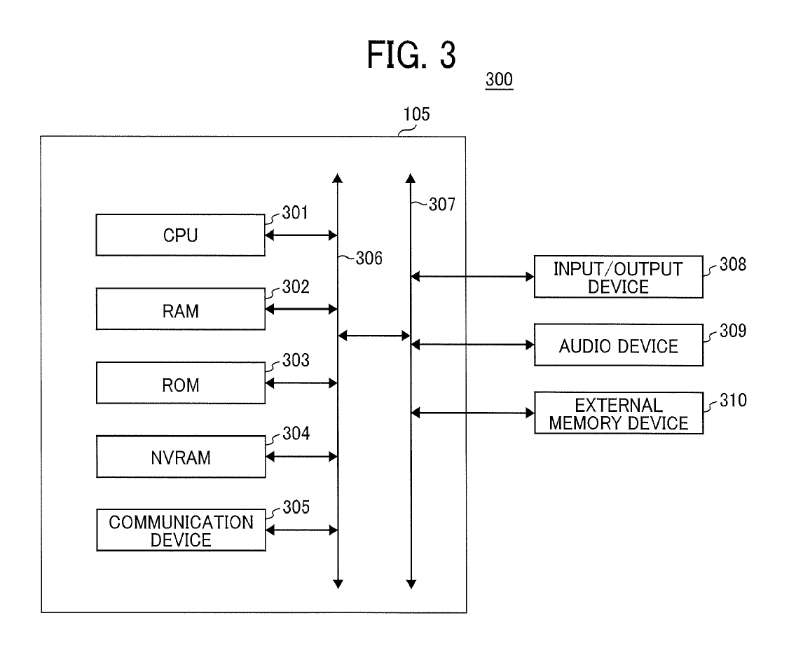

FIG. 3 is a diagram illustrating a hardware block 300 of the smartphone 105 as an example of the information terminal. The smartphone 105 includes a CPU 301, RAM 302, ROM 303, non-volatile RAM (NVRAM) 304, and a communication device 305 connected to each other by a system bus 306. The RAM 302 reads a program and data stored in the ROM 303 and the NVRAM 304, and enables processing of the smartphone 105. In addition, the system bus 306 is connected to an I/O bus 307 via a bus bridge such as PCI or PCI Express.

The I/O bus 307 includes an input/output device 308 such as a touch panel, a microphone, and a key, and an audio device 309 for enabling a call, via an appropriate protocol, and provides a telephone function and in addition a function as the information terminal for the user. Further, the smartphone 105 is connected to an external memory device 310 such as the SD card, and enables storing and processing of downloaded images, files, and the like. Incidentally, the input/output device 308 can be configured as an operation panel including a touch sensor in a case where the information processing device is the smartphone 105 or the tablet PC 104.

The CPU 301 used by the smartphone 105 includes Tegra (registered trademark), Exynos (registered trademark), and Snapdragon (registered trademark) used exclusively by a mobile terminal; however, the present embodiment is not limited to these CPUs.

In addition, the operating system (OS) to be used includes MacOS (registered trademark), iOS (registered trademark), Windows (registered trademark), CHROME (registered trademark), ANDROID (registered trademark), or another appropriate OS, but is not limited to these OSs. Further, the smartphone 105 can store and execute an application program written in a model-dependent programming language referred to as a so-called “app” in recent years, in addition to the assembler language, C, C++, Visual C++, Visual Basic, Java (registered trademark), Perl, or Ruby, the program being operated on the above described OS.

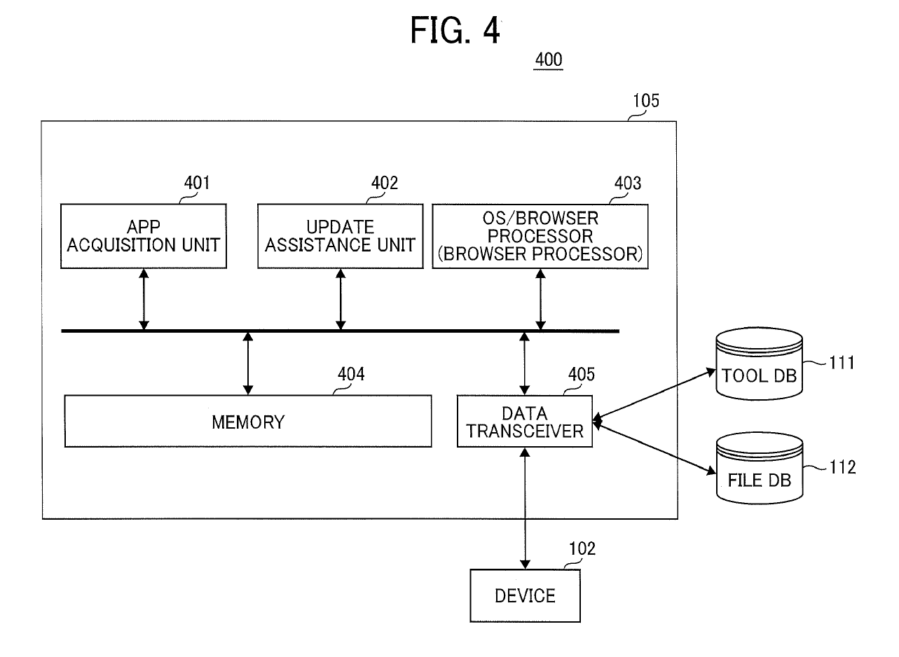

FIG. 4 is a diagram illustrating a function block 400 of the smartphone 105 as an example of an information terminal of the present embodiment. Incidentally, the function block 400 of FIG. 4 is a function unit realized on the information terminal, in which the CPU 301 reads a program into the RAM 302, and the CPU 301 executes the program, to control each hardware unit of the smartphone 105.

The smartphone 105 includes an app acquisition unit 401, an update assistance unit 402, and an OS/browser processor 403. The app acquisition unit 401 corresponds to an installer of the present embodiment, and provides a function that causes the server 110 to download and install an app via the network 101, in accordance with the present embodiment. Incidentally, the app acquisition unit 401 itself also can be implemented as an app, and can be provided by a user service function of the server 110, for example.

The update assistance unit 402 corresponds to an update assistance unit of the present embodiment, and provides a function that uses browser software as the agent out of the OS/browser processor 403 in accordance with the present embodiment, downloads a file and a program such as update firmware, transmits the program to the device 102, and relays update of the device. Incidentally, in the present embodiment, an electronic device can be an image processing device (MFP) as an example, and the information terminal can be the smartphone 105. In the present embodiment, the smartphone 105 includes the update assistance unit 402, and transfers various types of information downloaded to the device 102 such as the image processing device. The update assistance unit 402 is started by completion of download of information, and transfers the information to the device 102 such as the image processing device (MFP).

The OS/browser processor 403 corresponds to a downloader of the present embodiment, and controls the entire smartphone 105 and operates the browser software to download update data such as a program and other data, in a pull method, in accordance with HTTP 2.0. The downloaded program and the data are passed as arguments at the time of calling the update assistance unit 402, and provided for updating the device 102.

Incidentally, as the browser software, for example, Safari (registered trademark), CHROME (registered trademark), Mozilla (registered trademark), OPERA (registered trademark), and Fire Fox (registered trademark) can be used; however, the browser software is not limited to these browsers.

Hereinafter, since the present embodiment does not include any special change related to the function of the OS directly, for convenience of explanation, the OS/browser processor 403 is simply referred to as the browser processor 403.

Further, the smartphone 105 includes memory 404 and a data transceiver 405. The memory 404 corresponds to shared memory of the present embodiment, and is a memory area provided exclusively by the RAM 302 or the like illustrated in FIG. 3, and a part of the memory can be arbitrarily provided by built-in nonvolatile memory such as the NVRAM or the external memory device 310 such as the SD card. The memory 404 provides a memory area to store, for example, browsing data, download files, and a history in a case where the browser processor 403 browses the Internet.

The data transceiver 405 corresponds to a data transceiver of the present embodiment, and enables accessing the network 101 such as the Internet in a WiFi method to download a tool from the tool DB 111 managed by the server 110 and to download a program, update data, and other data from the file DB 112. Further, the data transceiver 405 enables transmission of the program and the data to the device and transmission of information to the device 102 under a wireless communication method of the WiFi method, Bluetooth method, or IEEE802.11x method with the device 102. Incidentally, the data transceiver 405 may use non-contact type proximity communication such as the NFC, in addition to the above described communication method.

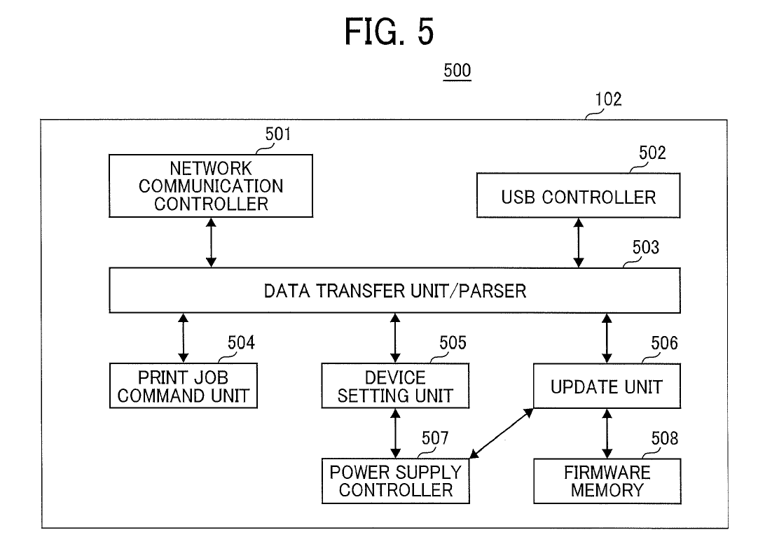

FIG. 5 illustrates a function block 500 of the device 102 of the present embodiment. The device 102 includes a network communication controller 501, a USB controller 502, and a data transfer unit/parser 503. The network communication controller 501 corresponds to a network communication controller of the present embodiment, and enables a wired network using a network interface card (NIC), for example, and in addition wireless communication using a WiFi router.

The USB controller 502 corresponds to a USB controller of the present embodiment, and enables reading/writing information from/to an external device to be connected via a USB. The data transfer unit/parser 503 provides a function that analyzes a destination from the information received via the network communication controller 501 or USB, and, for example, interprets an Internet Protocol (IP) address and a command included in a communication packet, and transfers the IP address and the command to an upstream function unit.

Further, the device 102, in the present embodiment, includes a print job command unit 504, a device setting unit 505, and an update unit 506. The print job command unit 504 corresponds to a print job command unit of the present embodiment, and provides a function that uses the received command and data to command printing to the print engine 211. The device setting unit 505 corresponds to a function setting unit of the present embodiment, and provides a function that sets a function of the device 102 on the basis of the received command and data.

Further, the update unit 506 corresponds to an update unit of the present embodiment, and can include a ROM writer, and writes an execution code of the received program into firmware memory 508 provided by the ROM 203. After the writing succeeds, the update unit 506 issues a reset command to a power supply controller 507 at appropriate timing, and causes the RAM 202 to read the execution code written into the firmware memory 508, and enables execution of the program after the update by the CPU 201. Incidentally, an updated app can be started in response to completion of download of information such as the file and the program. More specifically, the updated app can be started at the completion of download. However, the start and call of the updated app may be performed at the start of download or during download.

Using the function block illustrated in FIG. 5, the device 102 uses the update data acquired by the information terminal from the file DB 112 to update the device 102, and can continue the processing in the most suitable environment.

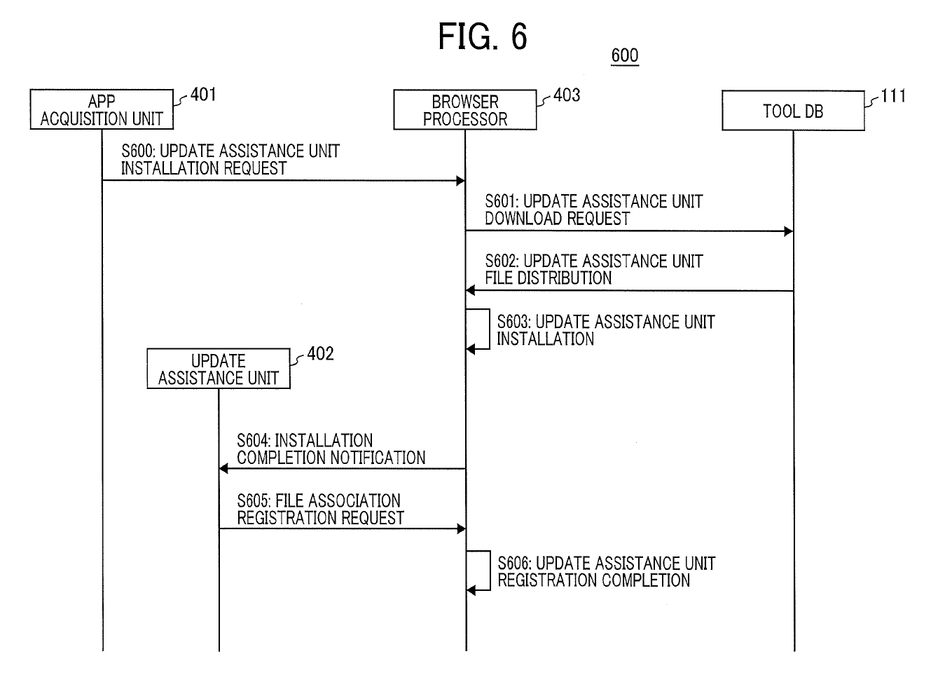

FIG. 6 is a diagram illustrating a processing sequence 600 between the server 110 and the smartphone 105 of the present embodiment. Incidentally, the processing sequence 600 illustrated in FIG. 6 accesses the tool DB 111 managed by the server 110 to install a tool for the smartphone 105 to acquire a program. Since processing of search and download between the server 110 and the tool DB 111 is not the gist of the present embodiment, the processing will be briefly described.

When the user calls the browser processor 403 in sequence S600 from the app acquisition unit 401 including an app for acquiring a tool of the present embodiment, the browser processor 403 receives a URL for uniquely identifying the update assistance unit 402 of the tool DB 111 from the app acquisition unit 401 as an argument, and requests download of a file of the update assistance unit 402 from the server 110, in sequence S601. The server 110 searches the tool DB 111, and reads the file specified by the URL, and distributes the file for the update assistance unit 402 to the browser processor 403 in sequence S602. Here, the browser processor 403 can pass a path through which the downloaded file is stored (file storage location of information terminal) and a file name (file identification value) to the update assistance unit 402 via the OS.

The browser processor 403 receiving the execution code of the tool executes installation processing of the update assistance unit 402 in sequence S603, and enables the update assistance unit 402 to be executed by the smartphone 105, and notifies the update assistance unit 402 itself of installation completion in sequence S604.

When receiving the notification, the update assistance unit 402 notifies and requests the browser processor 403 of registration of association between a component to be used by the update assistance unit 402 and an attribute of the file to be used as an argument at the start, for example, an extension, in sequence S605. When receiving the notification, the browser processor 403 starts registration of the update assistance unit 402 in sequence S606, and completes registration as the app of the browser processor 403.

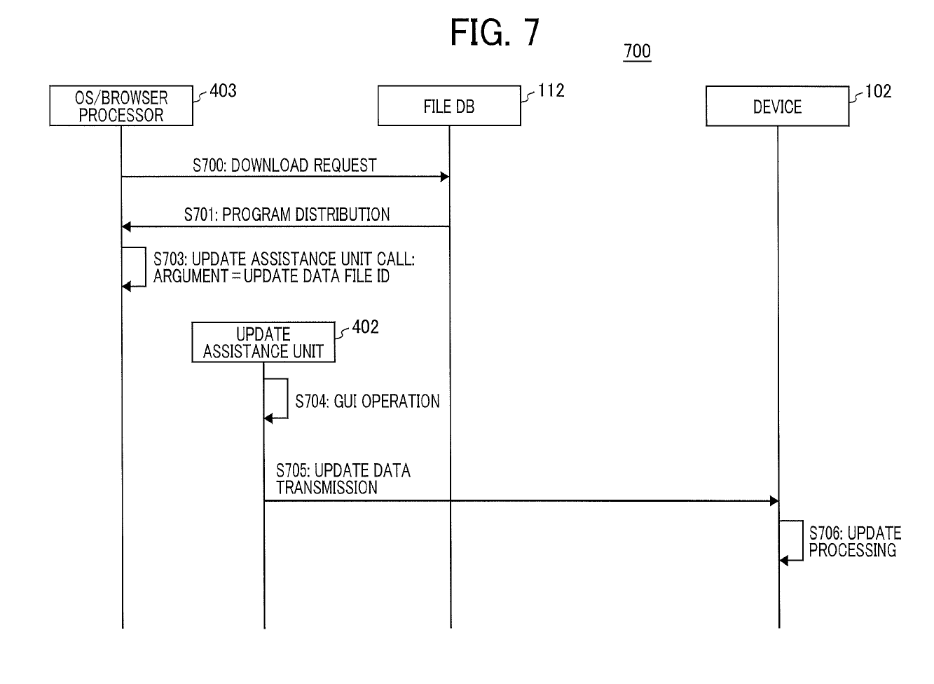

FIG. 7 is a diagram of a processing sequence 700 of update of the device by the update assistance unit 402 installed in the processing sequence 600 of FIG. 6. It will be described assuming that the user operates the browser processor 403 to access the URL listing items of the file DB 112 of the server 110. The user issues a download request for a program to be updated to the file DB 112 in sequence S700. When reading a file of the program requested from the file DB 112 and distributing the file to the browser processor 403 as a program in sequence S701, the server 110 performs buffering in the memory 404 managed by the browser processor 403.

When the buffering is performed, the browser processor 403 passes a file identification value (ID) as an argument in sequence S703, and calls the update assistance unit 402. At this time, the file identification value cached is passed as the argument to the update assistance unit 402 called. In sequence S704, the user operates a graphical user interface (GUI) provided by the update assistance unit 402 to perform operation such as search for the device 102, program validation using electronic signature or the like, and update command.

When the user instructs update from the GUI provided by the update assistance unit 402, the update assistance unit 402 calls a WiFi router function, a NFC function, and the like and transmits the program to the device 102 in sequence S705. The device 102 receiving the program executes update processing in sequence S706 at appropriate timing, to update the program such as the firmware of the device 102.

The processing sequence 700 illustrated in FIG. 7 can be applied not only to the OS having high shielding property, but also to a relatively freely open OS. For this reason, the update assistance unit 402 of the present embodiment can provide the agent for updating the device 102 regardless of the model of the information terminal.

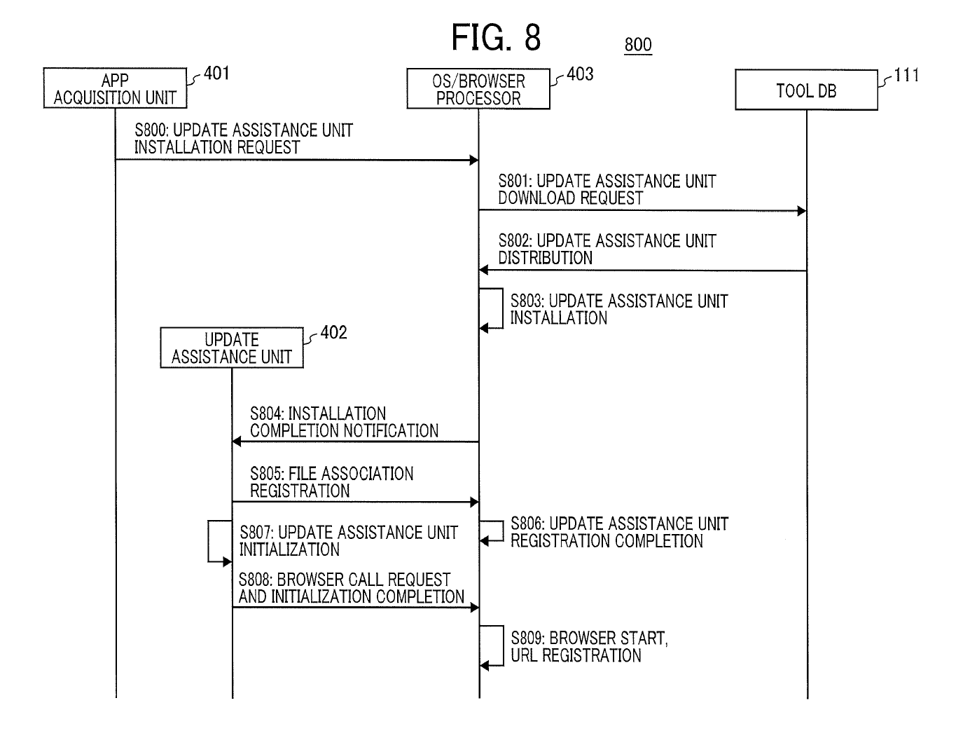

FIG. 8 illustrates a processing sequence 800 of a second embodiment executed by the app acquisition unit 401 of the present embodiment, in the present embodiment. The embodiment of FIG. 8 illustrates the processing sequence 800 that enables, for example, registering the URL of the file DB 112 in the browser processor 403 as, for example, a favorite or a bookmark, at installation completion of the update assistance unit 402 in a case where the user executes update of the firmware and the like. According to the embodiment of FIG. 8, the user can exclude redundant operation to access the URL providing an update file of the firmware or the like for each time of update, and an efficient update environment can be provided.

The processing sequence 800 of FIG. 8, in sequences S800 to S803, is similar to the processing sequence of FIG. 6. However, the file of the update assistance unit 402 installed in sequence S803 additionally include a URL storing a file required for update and the like or a URL for accessing the file DB 112 stored in the file, as data.

When receiving installation completion notification from the browser processor 403 in sequence S804, the update assistance unit 402 requests file association registration of the browser processor 403 in sequence S805. Specifically, a type of the file to be associated with the update assistance unit 402 is registered. The browser processor 403 completes update assistance unit registration in sequence S806. On the other hand, the update assistance unit 402 issuing the file association registration request in sequence S805 starts initialization processing of the update assistance unit 402 in sequence S807. Incidentally, the type of the file registered to be associated with the update assistance unit 402 includes specifically “.dat” “.rfu”, but is not limited to these types. In addition, when the type of the file downloaded by the browser coincides with the type of the file registered, the update assistance unit 402 is called.

After that, in sequence S808, the update assistance unit 402, as final processing of the initialization processing, calls the browser processor 403 using the URL downloaded as data with the file of the update assistance unit 402 as an argument, for example, and the update assistance unit 402 is immediately ended.

The reason for this is to avoid in advance a problem caused by overlapping start of apps at the time of calling by the browser processor 403 afterwards. After the processing, the user is guided to a site to access the file DB 112 or the server 110 storing the update data, and can access the data to be updated immediately after installation of the update assistance unit 402, and can perform more efficient update operation.

Incidentally, in another embodiment, the app acquisition unit 401 also can receive notification of initialization processing completion of the update assistance unit 402 and call the browser processor 403. The browser processor 403 called can register the URL indicating a file for performing update in a bookmark or a favorite, in response to a command by the user.

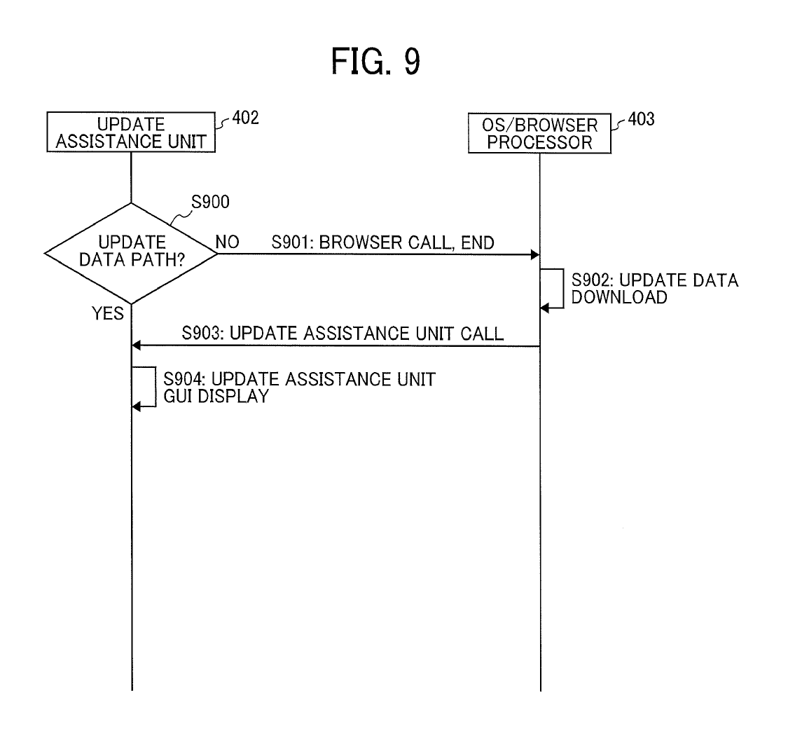

FIG. 9 illustrates a sequence of yet another embodiment executed by the update assistance unit 402 of the present embodiment. The embodiment of FIG. 9 corresponds to start processing of when the user touches a display for starting the update assistance unit 402 displayed on a touch panel (a so-called icon, hereinafter referred to as a button icon). The embodiments of up to FIG. 8 have been described assuming that the browser processor 403 directly starts the update assistance unit 402, for the purpose of describing the function in detail. However, it is not efficient for the user to start from download of the update assistance unit 402 for each time, when the device 102 is updated. On the other hand, when being started by the user, the update assistance unit 402 does not function even if being started since the file to be processed is not specified. In the worst case, an exception error may occur, and the entire program may be stopped.

To avoid these adverse effects, the processing of FIG. 9 is an embodiment additionally including processing corresponding to an icon touch event by the user. When the user touches the button icon for starting the update assistance unit 402 from the touch panel, the update assistance unit 402 determines whether or not an update data path for the file of the program is specified in sequence S900. In a case where the path is not specified (NO), the update assistance unit 402 calls the browser in sequence S901, and passes the URL for accessing the file DB 112 as the argument, for example. When the processing ends, the update assistance unit 402 ends temporarily in preparation for a subsequent call from the browser processor 403.

The browser processor 403 uses the value of the passed URL to access the file DB 112, and downloads desired update data in sequence S902. When the download is completed, the browser processor 403 calls the update assistance unit 402 in sequence S903 to display the GUI of the update assistance unit 402, and enables the user to perform operation of the update assistance unit 402 via the GUI in sequence S904.

On the other hand, in a case where the update assistance unit 402 can use the update data path already at the start (YES), the update assistance unit 402 displays the GUI of the update assistance unit 402 immediately in sequence S904, and allows the user to continue processing for updating the device 102. Such a situation is effective, for example, in a case where the processing is temporarily stopped since communication situation is bad after the completion of the download of the program, and in a case where, for example, there is an incoming call of a mobile phone during the update processing, and the processing of the update assistance unit 402 is suspended and then re-started.

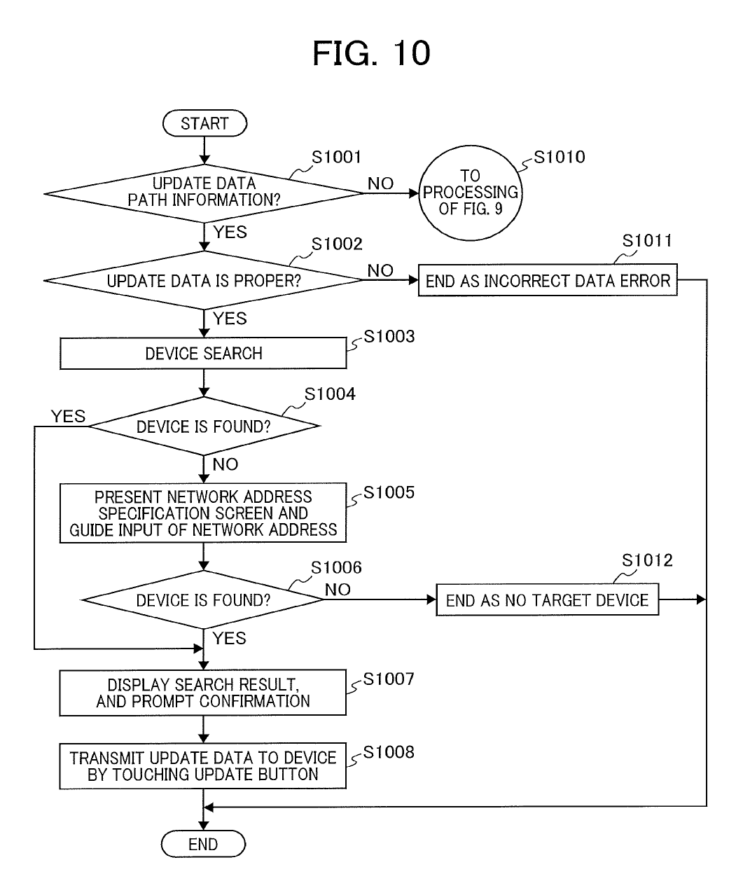

FIG. 10 is a flowchart illustrating processing after the update assistance unit 402 of the present embodiment is started until the user updates the device 102. The processing of FIG. 10 starts from step S1000, and determines whether or not there is update data path information in step S1001. In a case where there is no update data path information (NO at S1001), the processing is passed to the processing of FIG. 9 in step S1010. In a case where there is the update data path information in step S1001 (YES at S1001), electronic signature attached by the vendor and the like are used and it is determined whether or not the program information is proper in step S1002.

In a case where it is determined that the program is not proper in the determination in step S1002 (NO at S1002), an error message of an incorrect data error is displayed in step S1011, and the processing goes to end. On the other hand, in a case where it is determined that the program is proper in the determination in step S1002 (YES at S1002), search for the device 102 corresponding to the program is performed in step S1003. In this search, it is possible to use a device search protocol according to the OS being used.

The protocol includes Bonjour (registered trademark) in iOS (registered trademark), SMB in Windows (registered trademark), NETBIOS over TCP/IP, and SNMP, but is not limited to these protocols. In addition, device search in step S1003 can be automatically executed referring to model information described in metadata attached to the update data, and the like.

In step S1004, a result of the device search is received, and it is determined whether or not the device is found. In a case where the device is not found (NO at S1004), in step S1005, network address specification screen is presented, and the user is guided to input an IP address of the device 102 to be updated. Incidentally, in a case where the user is a service person, the IP address of the device 102 can be used as management data. In addition, also in a case of a general user, setting is possible referring to the IP address set by the manufacturer.

After the user inputs the network address such as the IP address in step S1005, the update assistance unit 402 re-searches for the device 102 in step S1006, and determines whether or not the device 102 is found. In a case where the device is not found again in step S1006 (NO), an error message of no target device is displayed in step S1012, and the processing ends.

On the other hand, in a case where the device 102 is found in step S1004 or step S1006 (YES), the search result is displayed in step S1007, and the user is prompted to confirm. After the user confirms the search result, when the user touches the button icon for update displayed on the GUI in step S1008, the program is read from the memory 404 and transmitted to the device 102 to be updated in step S1008, and the processing ends.

Afterwards, the device 102 receiving the program can operate the update unit 506 and the power supply controller 507 and install the update data to update the device 102.

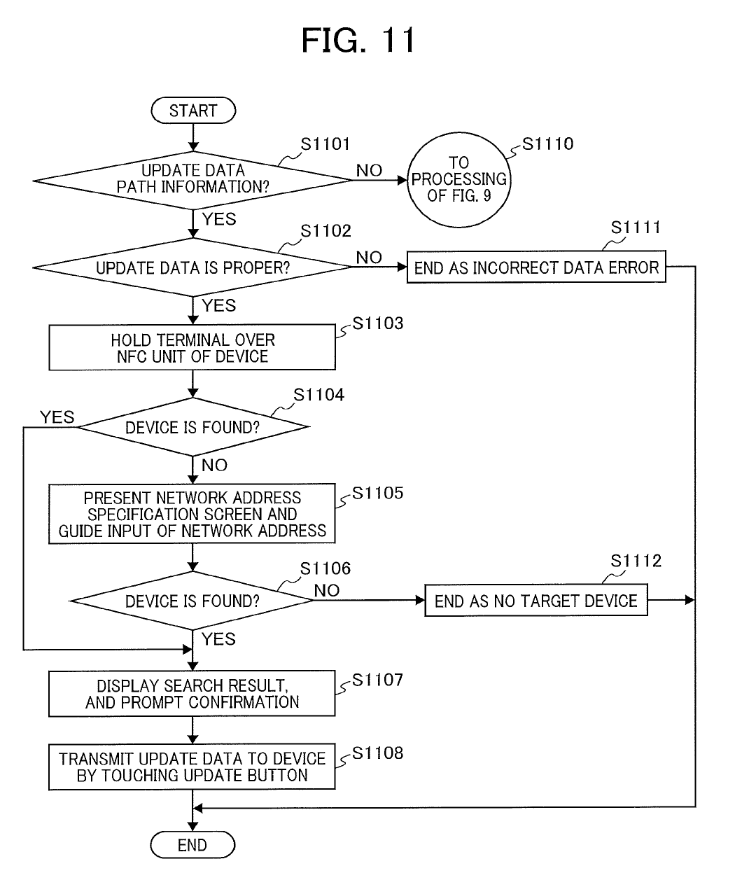

In addition, FIG. 11, similarly to FIG. 10, is a flowchart illustrating processing after the update assistance unit 402 of the present embodiment is started until the user updates the device 102. The processing of FIG. 11 is an example in a case where the smartphone 105 and a NFC communication function of the device 102 are used to acquire the model information. Incidentally, out of the processing of FIG. 11, description of the processing described in FIG. 10 will be omitted as appropriate.

The processing of FIG. 11 starts and determines presence of the update data path information and whether the update data is proper in steps S1101 and S1102. The processing of steps S1101 and S1102 corresponds to the processing of steps S1001 and S1002, and the processing after branching by the determination result is also similar to the processing of FIG. 10.

In a case where it is determined that the program is proper in the determination in step S1102 (YES), the user performs holding operation of the smartphone 105 over the device 102, and acquires the model information including the IP address, in step S1103. Here, the holding operation in step S1103 means operation to bring the smartphone 105 and the device 102 close to each other within a range in which communication by the NFC is possible.

After the model information is acquired by the NFC in step S1103, the device search result is received, and it is determined whether or not the device is found, in step S1104. In a case where the device is not found (NO), the processing proceeds to step S1005, and in a case where the device 102 is found (YES) the processing proceeds to step S1007. Incidentally, the processing of step S1104 and subsequent steps of S1105 through S1108, and branching steps S1110 through S1112 in FIG. 11 are the same as the processing of step S1004 and subsequent steps of S1005 through S1008, and branching steps S1010 through S1012 in FIG. 10, so that the description will be omitted.

In this way, by using the NFC, acquisition of the device information can be easily and reliably performed. In the following, an example will be described of a screen displayed in the present embodiment.

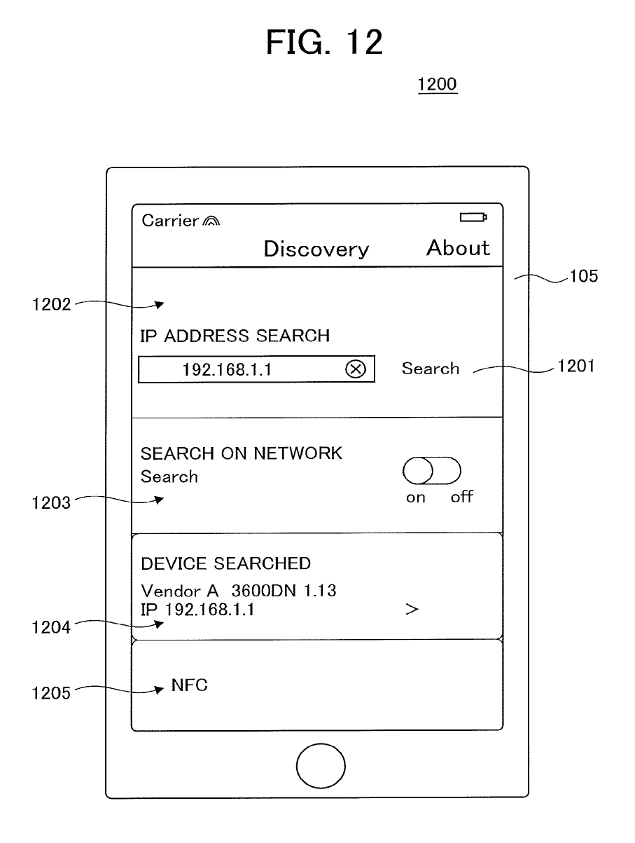

FIG. 12 illustrates an embodiment of a GUI 1200 corresponding to a user interface of the present embodiment provided by the update assistance unit 402 when the smartphone 105 that is one embodiment of the information terminal of the present embodiment is used to update the device. The GUI 1200 displays a screen to select how to acquire the model information (NFC touch, address specification, device search, or the like), and the user can select from various acquisition methods displayed on the screen. On the touch panel 1201 of the smartphone 105, a GUI 1202 of IP address search is displayed. The user directly inputs that the IP address of the device 102 as a search target is 192.168.1.1, for example. On the touch panel 1201 of the smartphone 105, for example, the GUI 1203 is also displayed to automatically search a device on the network by, e.g., broadcast. The user may select the device displayed on the touch panel 1201.

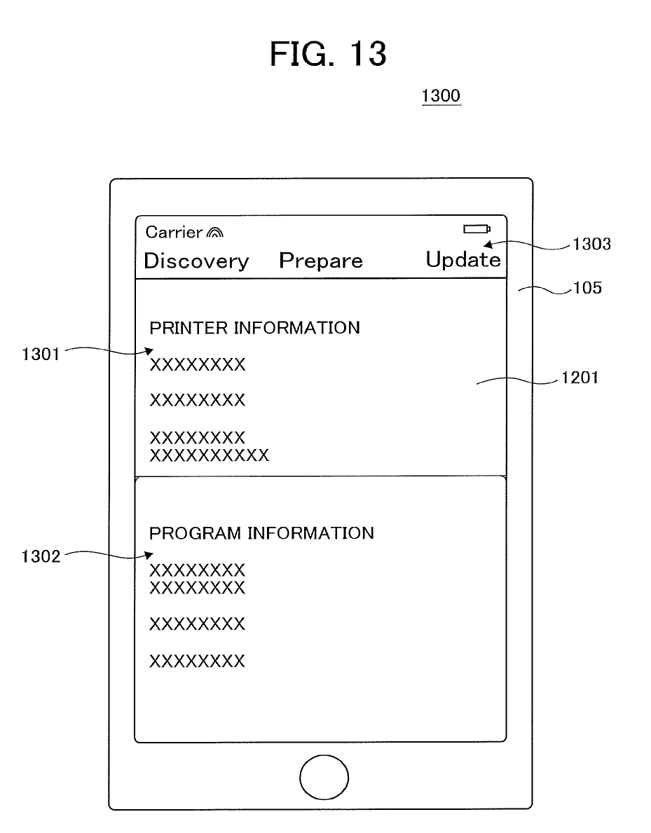

After inputting the IP address, the user touches “Search” from the GUI for commanding search, thereby being able to start the search. In a GUI 1204, a search result is displayed, and a vendor name, a model name, and an assigned IP address are displayed. The user confirms the search result in the GUI 1204, and, for example, touches an area displaying the model name in the GUI 1204, whereby a device confirmation screen illustrated in FIG. 13 is displayed.

FIG. 13 is an embodiment of a GUI 1300 of the device confirmation screen presented by the update assistance unit 402 of the present embodiment. On the touch panel 1201, a GUI 1301 displaying device information and information of the update data to be installed are displayed. After confirming each piece of the information, for example, the user touches the “Update” button icon 1303 arranged in the upper right of the touch panel 1201, whereby instruction of transfer is performed to the update data of the file identification value displayed in a GUI 1302. After that, the update data is transmitted from the data transceiver 405 to the device 102, and is used for updating the device.

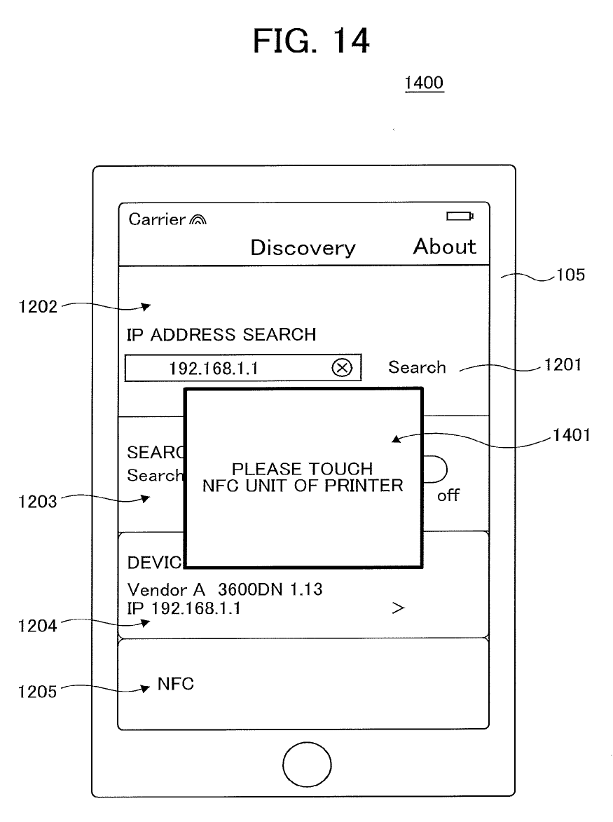

The description is returned to FIG. 12. In a GUI 1205, a display is made to select a NFC mode in which the user holds the terminal to detect the device 102 and acquires the model information. The user touches the area of the GUI 1205, whereby the pop-up screen illustrated in FIG. 14 is displayed.

FIG. 14 is a diagram illustrating an embodiment of a GUI 1400 to be displayed when the smartphone 105 that is one embodiment of the information terminal of the present embodiment is used to acquire the device information by the NFC. To prompt acquisition of the model information by user's holding operation of the smartphone 105, for example, the pop-up screen 1401 displays “Please touch the NFC unit of the printer”. The user viewing the display performs holding operation of the smartphone 105 over the device 102 to be updated, whereby the model information is acquired.

When the model information is acquired, the screen transitions to the GUI screen illustrated in FIG. 13. The user touches the “Update” button icon, whereby the update data can be transferred to the device 102. In this way, by using the NFC, a procedure to search for and select the device by the user can be omitted, and the update can be easily performed.

As described above, in the present embodiment, it is possible to select a method for acquiring the model information of the device 102 to be updated, and convenience for the user can be improved.

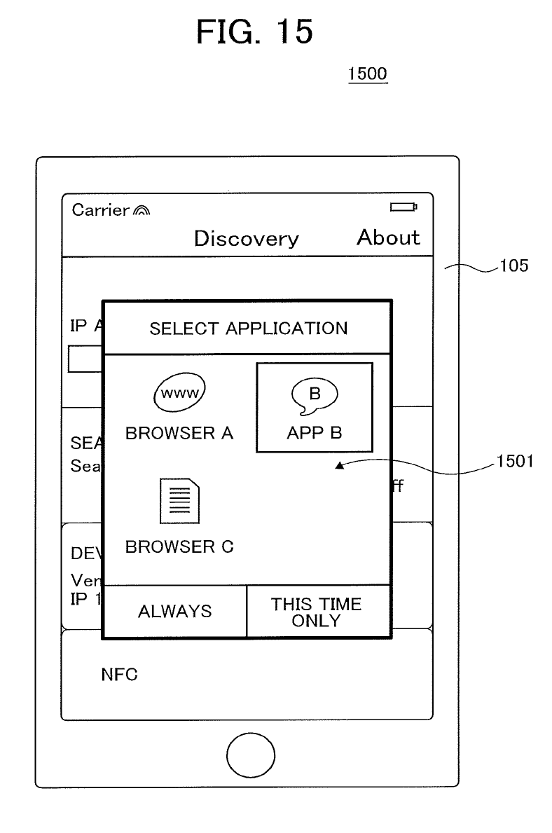

In the embodiments described so far, the description has been made in a case where the update assistance unit 402 and the browser processor 403 are separate apps from each other. In such a case, the user needs to select on the OS an app to be used out of apps associated with the file format of the update file downloaded, and perform app cooperation operation. FIG. 15 is a diagram illustrating an example of a GUI 1500 of an app selection screen displayed by the OS of the present embodiment.

In the present embodiment, at the completion of download of the update data, the update assistance unit 402 is started. In a case where there is a plurality of apps associated with the file format of the update data, an app selection display 1501 illustrated in FIG. 15 is pop-up displayed, and the user is prompted to select the app. In such a case, it takes time for the user to select the app, and there is a possibility of mistaking selection of the appropriate app, and inconvenience occurs.

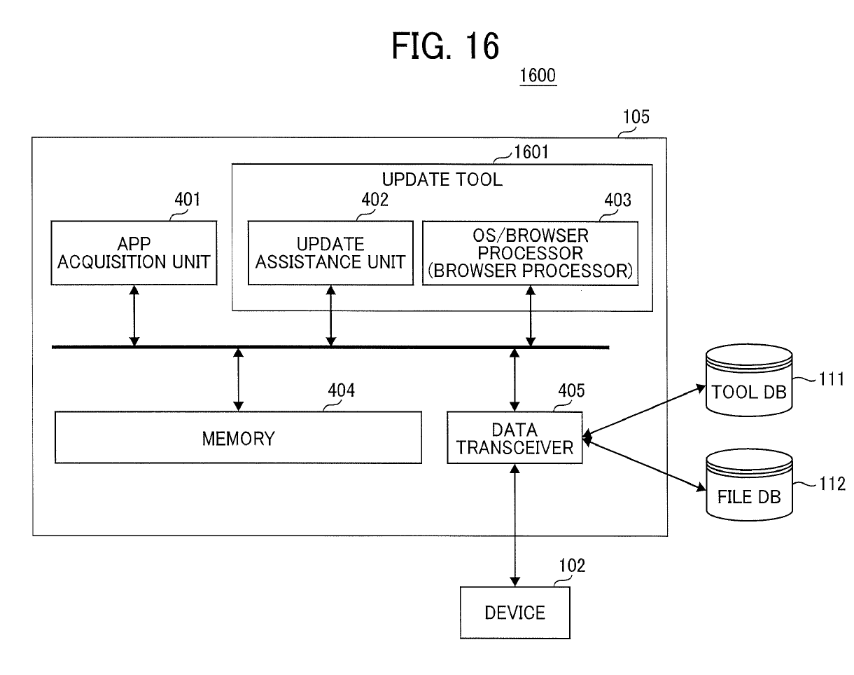

Therefore, the update assistance unit 402 and the browser processor 403 may be integrated together. FIG. 16 is a diagram illustrating a function block 1600 of the smartphone 105 as an example of an information terminal including an update tool having an integrated configuration in the present embodiment. As illustrated in FIG. 16, an update tool 1601 has functions of the update assistance unit 402 and the browser processor 403, and can link an update function and a browser function with each other in the update tool 1601. Therefore, as described above, even in a case where there is the plurality of apps, the update function and the browser function can be linked with each other without performing selection operation by the user, and a user's burden can be reduced.

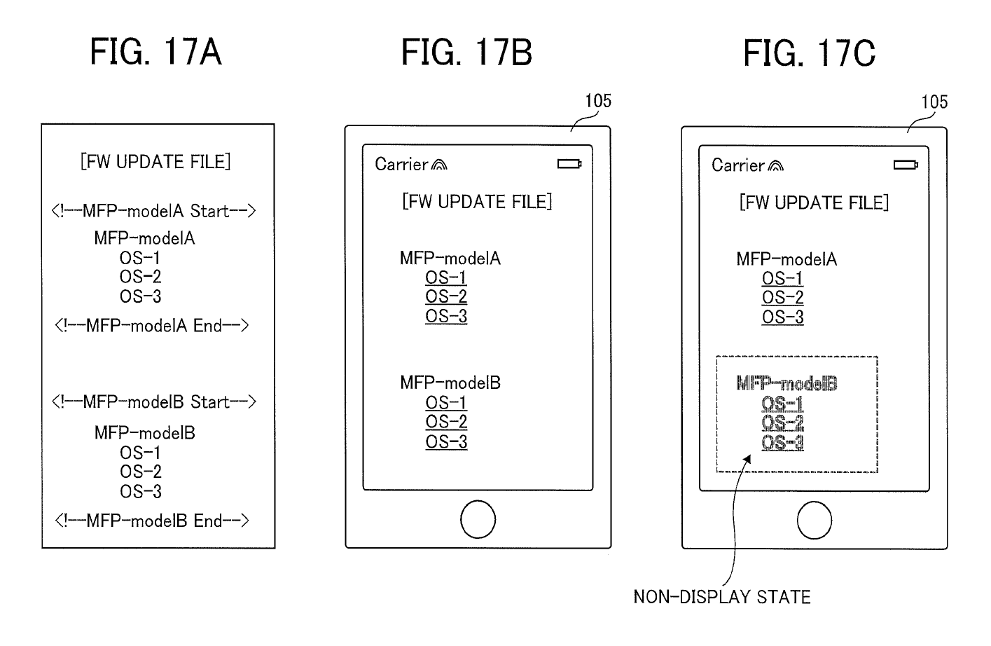

In addition, in a download site of the update file, the update file may be displayed of another device dealt by the manufacturer of the update target device, or for each OS used. FIGS. 17A to 17C are diagrams illustrating examples of a screen of a web page to download the update file. FIG. 17A illustrates an example of the data on the server describing the download site with a language such as Hypertext Markup Language (HTML). In addition, FIG. 17B illustrates an example of a screen displaying the source code illustrated in FIG. 17A by a normal browser, and FIG. 17C illustrates an example of a screen displaying the source code illustrated in FIG. 17A by the browser function of the update tool 1601 of the present embodiment.

In the source code illustrated in FIG. 17A, update files of various OSs are prepared for each update target model, together with a title “firmware (FW) update file”. In the example of FIG. 17A, a model “MFP-modelA” and a model “MFP-modelB” exist, and update files corresponding to various OSs “OS-1”, “OS-2”, and “OS-3” exist for each model. In addition, in HTML, a tag can be embedded to specify non-display of contents, of the source code. For example, description enclosed in tags “<<!--” and “-->>” illustrated in FIG. 17A (hereinafter, referred to as non-display tags) can be hidden on the browser.

Therefore, in a case where the source code of FIG. 17A is displayed in the normal browser, the screen as FIG. 17B is displayed. In the normal browser, a character string enclosed in the non-display tags is hidden, and a link is displayed to update files corresponding to the various OSs “OS-1”, “OS-2”, and “OS-3” for each of the “MFP-modelA” and “MFP-modelB”.

However, in the display on the normal browser illustrated in FIG. 17B, the update file is displayed for each device name and OS name, so that the user needs to select a device name of the update target and the OS used by the terminal that performs update. In such a case, it takes time for the user to select the update target device and the OS, and there is a possibility of mistaking selection of the appropriate file, and inconvenience to the user occurs.

On the other hand, as described above, the update tool 1601 of the integrated configuration can hold information on the model to be updated, and the OS operating in the terminal. Therefore, it is possible to use the browser function included in the update tool 1601 to identify the character string described within the non-display tags, and display a screen browsing the model other than the update target model hidden.

FIG. 17C is a screen of the download site displayed by the browser function of the update tool 1601 of the integrated configuration, and the inside of the area indicated by the broken line is hidden. In FIG. 17C, a case is illustrated where the model to be updated is the “MFP-modelA”, and only the link of the download file of the model is displayed. In this way, the model to be updated can be displayed, and a user's burden to select the file can be reduced.

Incidentally, the update tool 1601 can recognize the environment where the update tool 1601 operates. Therefore, the OS can also be made non-display similarly, so that the user's burden to select the OS can be reduced, and convenience can be improved.

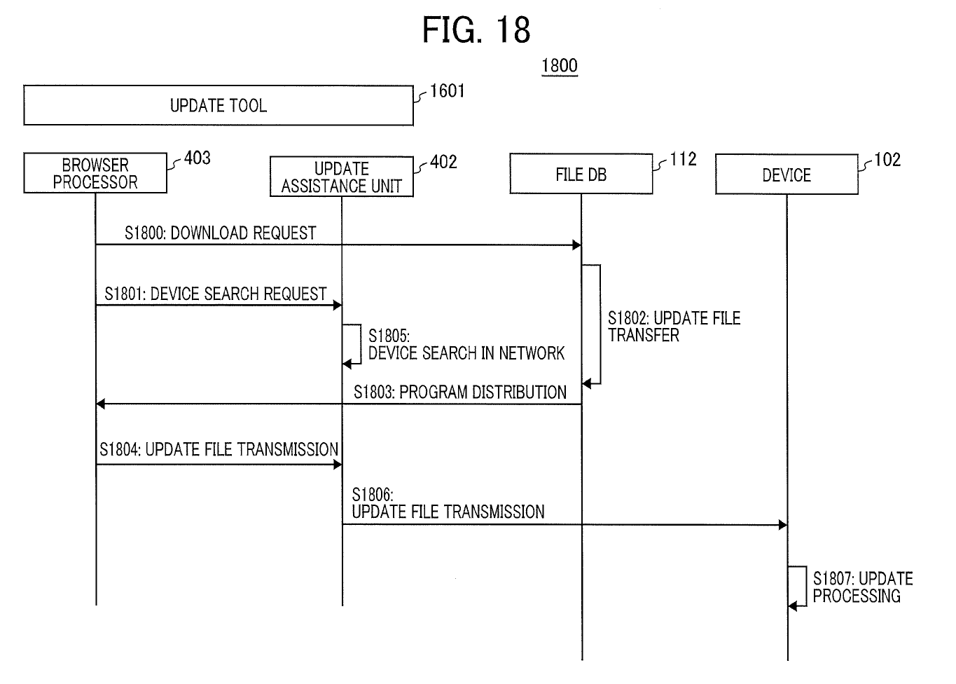

Next, processing performed by the update tool 1601 of the integrated configuration described above will be described with reference to FIG. 18. FIG. 18 is a diagram describing a sequence of update of the device by the update tool 1601. Incidentally, the processing sequence 1800 illustrated in FIG. 18 is partially common to the processing sequence 700 performed in FIG. 7, and detailed description thereof will be omitted as appropriate.

The user performs operation to select the update file of the update target device from the browser function of the update tool 1601, to start update. When the update is started, the browser processor 403 of the update tool 1601 issues a download request of the program to be updated to the file DB 112 via the OS, in sequence S1800. In addition, the browser processor 403 performs sequence S1801 in parallel with sequence S1800, and issues a device search request to the update assistance unit 402.

The file DB 112 receiving the download request performs processing of transferring the update file requested, in sequence S1802, and distributes the program of the update file to the browser processor 403, in sequence 51803. The browser processor 403 completing download of the program transmits the downloaded update file to the update assistance unit 402 in sequence S1804.

In addition, the update assistance unit 402 receiving the device search request searches for the device in the network in sequence S1805, and acquires the model information. The search processing preformed in sequence S1805 can be performed by using the various methods described above.

When both reception of the update file in sequence S1804 and device search in sequence S1805 are completed, the update assistance unit 402 transmits the update file received in sequence S1806 to the device 102 acquired in the search. Incidentally, in the example of FIG. 18, the update file is transmitted (S1804) and then the device search (S1805) is completed; however, depending on the time required for each process, the order may be changed.

The device 102 receiving the program of the update file executes update processing in sequence S1807 at appropriate timing, and updates the program such as the firmware of the device 102. Incidentally, the processing in sequence S1807 is similar to the processing in sequence S706.

The sequence illustrated in FIG. 18 can perform download of the update file that takes a relatively long time, and device search in the network in parallel, in a series of update processing. Thus, time can be reduced from when the user instructs to start update until update of the firmware is completed.

Incidentally, regarding timing, update of the device may be performed immediately after reception completion of the update data; however, it is also possible to delay the timing until the time period in which frequency of use of the device is not high, and execute the update.

As described above, according to the present embodiment, without requiring additional functions or interfaces for the device, and regardless of the type of the OS, it is possible to provide a technique that enables efficient maintenance such as update of the device. Further, the present embodiment is effective to the OS having high shielding property that inhibits the application from directly specifying the file managed by the information terminal, but can also be used similarly in another OS having relatively low shielding property.

In the above, the present disclosure has been described with reference to the example embodiments; however, embodiments of the claimed invention are not limited to the embodiments. The embodiments of the present disclosure can be modified within a range that can be conceived by those skilled in the art, such as addition, modification, and deletion. Another embodiment and any aspect of the modification can be included in the scope of the present disclosure as far as the function and effect of the present disclosure are achieved.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information terminal to transfer information for updating an electronic device to the electronic device, the terminal comprising:
a downloader to download the information via a network;
a memory to store the information downloaded by the downloader; and
an update assistance unit to start with download of the information and to transfer to the electronic device the information stored in the memory by the download.

2. The information terminal according to claim 1, further comprising an installer to install the update assistance unit in the information terminal, starts the downloader at an end of installation of the update assistance unit, and display a site in which the downloader started accesses the information.

3. The information terminal according to claim 1,
wherein the update assistance unit provides a user interface to search for the electronic device as a destination of transfer of the information, display device information identifying the electronic device found and file identification information identifying the information downloaded, and instruct the electronic device, of which the device information is displayed, to transfer the information identified by the file identification information.

4. The information terminal according to claim 1,
wherein the information terminal refers to model information attached to the information downloaded and automatically starts searching for the electronic device as a destination of transfer of the information.

5. The information terminal according to claim 1,
wherein the information terminal operates on an operating system that does not permit specification of the information from an application included in the information terminal.

6. The information terminal according to claim 1,
wherein the information terminal, during installation of the update assistance unit, registers a type of the information to be associated with the update assistance unit, and starts the update assistance unit in a case where a type of the information downloaded by the downloader matches the type of the information registered.

7. The information terminal according to claim 1,
wherein the downloader passes, to the update assistance unit, path information indicating a location at which the information is stored, and the update assistance unit transfers the information specified by the path information to the electronic device.

8. The information terminal according to claim 1,
wherein the downloader is a general-purpose browser included in the information terminal, and the update assistance unit is an application addable to the information terminal.

9. The information terminal according to claim 1,
wherein the electronic device is an image processing device and the information terminal is a smartphone,
wherein the smartphone includes:
a browser as the downloader to download the information; and
the update assistance unit to transfer the information downloaded to the image processing device, and
wherein the update assistance unit starts in response to completion of download of the information and transfers the information to the image processing device.

10. The information terminal according to claim 1,
wherein the update assistance unit acquires device information identifying the electronic device as a destination of transfer of the information by Near Field Communication.

11. The information terminal according to claim 1,
wherein the downloader includes a general-purpose browser, and the downloader and the update assistance unit function by an identical application.

12. The information terminal according to claim 11,
wherein the general-purpose browser extracts information relating to the electronic device and displays a site.

13. The information terminal according to claim 11,
wherein the identical application executes processing to download the information by the downloader and processing to search for the electronic device by the update assistance unit in parallel.

14. An information processing system comprising:
an electronic device connectable to a network, to operate a program to provide a function; and
an information terminal to transfer information for updating the electronic device to the electronic device to assist updating of the electronic device,
the information terminal including:
a downloader to download the information via a network;
a memory to store the information downloaded by the downloader; and
an update assistance unit to start with download of the information by the downloader and transfer the information stored in the memory to the electronic device in response to completion of the download.

15. The information processing system according to claim 14, further comprising an installer to install the update assistance unit in the information terminal, start the downloader at an end of installation of the update assistance unit, and display a site in which the downloader started accesses the information.

16. The information processing system according to claim 14,
wherein the information terminal refers to model information attached to the information downloaded and automatically starts searching for the electronic device as a destination of transfer of the information.

17. A method for causing an information processing device to function as an information terminal to update an electronic device, the method to be executed by the information terminal,
the method comprising:
downloading, with a downloader, information to be used for updating the electronic device via a network;
sharing the information downloaded by the downloader with an application via a memory; and
transferring the information stored in the memory to the electronic device in response to completion of the downloading of the information by the downloader.

18. A non-transitory recording medium storing a device executable program that causes an information processing device to execute a method for causing the information processing device to function as an information terminal to update an electronic device,
the method comprising:
downloading, with a downloader, information to be used for updating the electronic device via a network;
storing the information downloaded by the downloader in a memory;
starting an update assistance unit with the downloading of the information by the downloader; and
transferring the information stored in the memory from the update assistance unit to the electronic device in response to completion of the downloading.
